(19) United States
(12) Patent Application Publication
(10) Pub. No.: US 2026/0229651 A1
(43) Pub. Date: Aug. 6, 2026

(54) SECONDARY BATTERY AND METHOD OF MANUFACTURING SECONDARY BATTERY

(71) Applicant: SAMSUNG SDI CO., LTD., Yongin-si (KR)

(72) Inventor: Misun LEE, Yongin-si (KR)

(21) Appl. No.: 19/283,751

(22) Filed: Jul. 29, 2025

(30) Foreign Application Priority Data
Feb. 3, 2025 (KR) 10-2025-0013296

(51) Int. Cl. H01M 50/105

(52) U.S. Cl. CPC H01M 50/105

(57) ABSTRACT

A secondary battery includes a case and an electrode assembly accommodated in the case, the electrode assembly including a first electrode, a separator, and a second electrode stacked. A detachable member is attached to a first surface of the case, and a packaging member is disposed on a second surface of the case opposite to the first surface. The detachable member includes at least one detachable portion that is configured to be engageable to a fitting portion of a device.

### CROSS-REFERENCE TO RELATED APPLICATION

The present application claims priority to and the benefit of Korean Application No. 10-2025-0013296, filed on Feb. 3, 2025, in the Korean Intellectual Property Office, the entire disclosure of which is incorporated by reference herein.

### BACKGROUND

### Field

The present disclosure relates to a secondary battery and a method of manufacturing the secondary battery.

### Description of the Related Art

Unlike primary batteries that are not designed to be (re)charged, secondary (or rechargeable) batteries are batteries that are designed to be discharged and re-charged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly including a positive electrode and a negative electrode, a case accommodating the electrodes, and electrode terminals connected to the electrode assembly.

In batteries of small electronic devices such as smartphones, many pouch-type batteries with excellent flexibility and relatively light weight are used. Such pouch-type batteries can accommodate changes in component layout design for new model releases and requirements for weight reduction. However, when a pouch-type battery using a flexible composite material is mounted in a battery placement space and subsequently replaced, wrinkling or deformation may occur on an outer surface of the pouch. To address this problem, a prismatic case using stainless steel material with higher strength than aluminum has been proposed for small electronic device batteries. Nevertheless, in order to form a stainless steel prismatic case without defects, a stainless steel material with a thickness of greater than or equal to 100 μm is required, which increases the weight of the battery. Therefore, a lighter pouch-type battery is needed, with the pouch-type battery being easily attached to or detached from a device.

The above information disclosed in this background section is for enhancement of understanding of the background of the present disclosure. It may contain information that does not constitute related or prior art.

### SUMMARY

An aspect of the present disclosure is to provide a secondary battery and a method of manufacturing the secondary battery for addressing the above-described technical issues. These and other aspects and features of the present disclosure will be described in or will be apparent from the following description of embodiments of the present disclosure. It should be noted that the present disclosure is not limited to addressing any particular technical issue.

According to an embodiment of the present disclosure, a secondary battery may include a case; an electrode assembly accommodated in a case, with the electrode assembly including a first electrode, a separator, and a second electrode stacked; a detachment member attached to a first surface of the case; and a packaging member disposed on a second surface of the case that is opposite to the first surface. The detachment member may include at least one detachment portion that is configured to be engageable to a fitting portion of a device.

According to an embodiment of the present disclosure, the detachment member may include a joining surface in contact with the first surface of the case and a detachment surface opposite to the joining surface, and the detachment portion may include a sidewall on the detachment surface along at least a portion of the perimeter of the detachment member. The sidewall may protrude from the detachment surface.

According to an embodiment of the present disclosure, the sidewall may include a first sidewall and a second sidewall that face each other, and at least one of the first sidewall or the second sidewall may include a hook that is configured to be engageable to and detachable from the fitting portion.

According to an embodiment of the present disclosure, the detachment portion may include a groove that is configured to be engageable to and detachable from the fitting portion.

According to an embodiment of the present disclosure, the detachment member may include an elastic part.

According to an embodiment of the present disclosure, detachment member may be magnetic.

According to an embodiment of the present disclosure, a magnetic body may be located in or around the detachment member.

According to an embodiment of the present disclosure, the first magnet is configured such that a pole of the magnet is positionable to an opposite pole of a magnet of the fitting portion.

According to an embodiment of the present disclosure, the packaging member may include a handle for facilitating removal of the packaging member from the case.

According to an embodiment of the present disclosure, an adhesive layer may be interposed between the packaging member and the case.

According to an embodiment of the present disclosure, a plane of the packaging member may correspond to the shape of the second surface of the case.

According to an embodiment of the present disclosure, the packaging member may include a flame-retardant material.

According to an embodiment of the present disclosure, a plane of the detachment member may correspond to the shape of the first surface of the case.

According to an embodiment of the present disclosure, the secondary battery may further include a terminal portion electrically connected to the electrode assembly, and a protection circuit member electrically connected to the terminal portion.

A method of manufacturing a secondary battery according to an embodiment of the present disclosure for solving the technical problems may include stacking a first electrode, a separator, and a second electrode to form an electrode assembly; inserting the electrode assembly into a case; attaching a detachment member to a first surface of the case; and placing a packaging member on a second surface of the case that is opposite to the first surface, wherein the detachment member includes at least one detachment portion that is engageable to and detachable from a fitting portion of a device.

According to an embodiment of the present disclosure, placing the packaging member on the second surface of the case may include interposing an adhesive layer between the packaging member and the case.

A method of manufacturing a secondary battery according to an embodiment of the present disclosure may further include forming a terminal portion electrically connected to the electrode assembly and a protection circuit member electrically connected to the terminal portion.

According to some embodiments of the present disclosure, it is possible to provide a pouch-type secondary battery that is relatively light in weight and has excellent flexibility to meet demands for weight reduction, with the battery being configured so as to be easily attached to or detached from a device.

According to some embodiments of the present disclosure, it is possible to provide a secondary battery that offers easy coupling and orientation for a user so that there is no difficulty in manually attaching or detaching the secondary battery to or from a device.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The drawings illustrate embodiments of the present disclosure, and further describe aspects and features of the present disclosure together with the detailed description of the present disclosure. Thus, the present disclosure should not be construed as being limited to the drawings.

FIG. 1 is an exploded perspective view of a structure of a secondary battery according to an embodiment of the present disclosure.

FIG. 2 illustrates a case and an electrode assembly accommodated in the case of a secondary battery according to an embodiment of the present disclosure.

FIG. 3 is a cross-sectional view of a secondary battery according to an embodiment of the present disclosure coupled to a device.

FIG. 4 is illustrates an outline of a secondary battery according to an embodiment of the present disclosure.

FIG. 5 is illustrates an outline of a secondary battery according to an embodiment of the present disclosure.

FIG. 6 is illustrates an outline of a secondary battery according to an embodiment of the present disclosure.

FIG. 7 is a cross-sectional view of a secondary battery according to an embodiment of the present disclosure coupled to a device.

FIG. 8 is a cross-sectional view of a secondary battery according to an embodiment of the present disclosure coupled to a device.

FIG. 9 illustrates an outline of a secondary battery according to an embodiment of the present disclosure.

FIG. 10 is a flowchart of a method of manufacturing a secondary battery according to the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the terms to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when a layer or element is referred to as being “between” two layers, it can be the only layer between the two layers, or one or more intervening layers may also be present. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, com-ponent, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maxi-mum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of local patent laws.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be inter-posed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

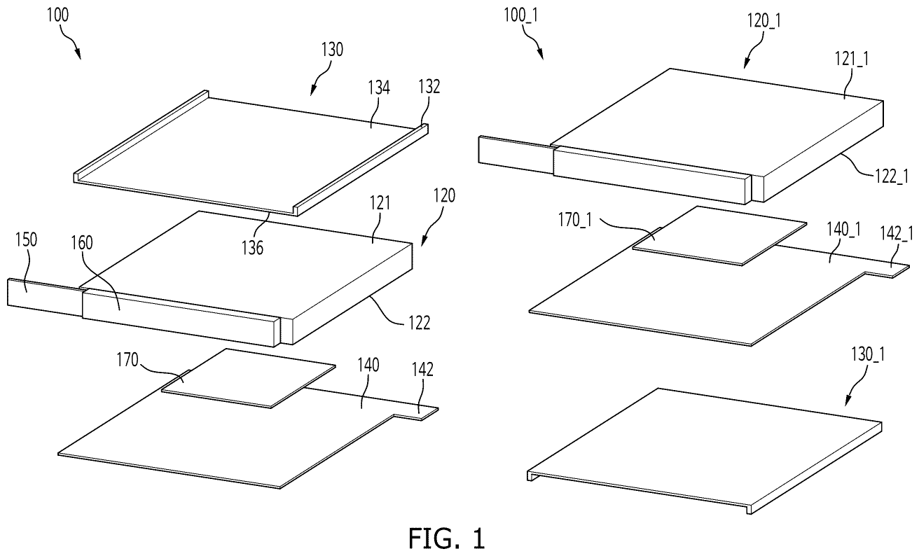

FIG. 1 is an exploded perspective view of a structure of a secondary battery according to an embodiment of the present disclosure.

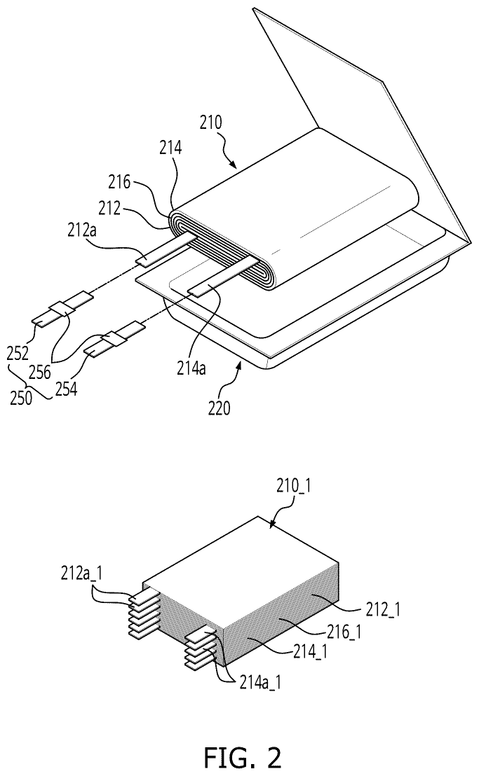

Referring to FIG. 1, a secondary battery 100 according to an embodiment of the present disclosure may include an electrode assembly in the form of a stack of a first electrode, a separator, and a second electrode. A case 120 accommodates the electrode assembly. In some examples, the secondary battery 100 is a pouch-type secondary battery. The electrode assembly and the case 120 accommodating the electrode assembly will be described below with reference to FIG. 2.

The secondary battery 100 may include a detachment member 130 attached to a first surface 121 of the case 120 and a packaging member 140 disposed on a second surface 122 of the case 120. Here, the second surface 122 of the case 120 may face (and be opposite to) the first surface 121 of the case 120.

The detachment member 130 may include at least one detachment portion 132 that engages a fitting portion of a device. For example, the detachment portion 132 may be integrally formed with the detachment member 130. A material having excellent strength may be used to form the detachment member 130 so that the detachment member 130 can provide supporting force when coupling with the fitting portion of the device. For instance, the detachment member 130 may include one or more of an engineering plastic such as polycarbonate, polyoxymethylene, or polybutylene terephthalate, a high-strength ceramic, a metal, or a combination thereof.

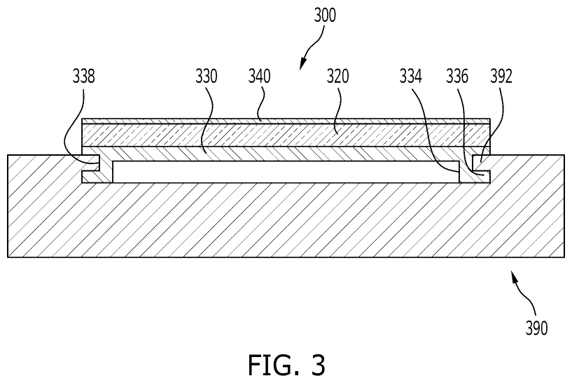

The detachment member 130 may include a joining surface 136 in contact with the first surface 121 of the case 120 and a detachment surface 134 opposite to the joining surface 136. The detachment portion 132 may be formed on the detachment surface 134 along at least a portion of the perimeter of the detachment member 130. The shape of the detachment portion 132 may correspond to the shape of the fitting portion of the device. For instance, the detachment portion 132 may include a sidewall protruding from the detachment surface 134. Various shapes of the detachment member 130 having the detachment portion 132 will be described below with reference to FIGS. 3 to 8.

The detachment member 130 may be attached integrally with the first surface 121 of the case 120. Specifically, an adhesive layer (not shown) may be interposed between the first surface 121 of the case 120 and the detachment member 130. The adhesive layer may be an insulating material having an adhesive property that is used in the art. For instance, the adhesive layer may include polyimide tape, acrylic adhesive, epoxy adhesive, polyurethane film, silicone adhesive, or a combination thereof.

A plane of the detachment member 130 may correspond to the shape of the first surface 121 of the case 120. Specifically, the joining surface 136 of the detachment member 130 may correspond to the shape of the first surface 121 of the case 120 such that the detachment member 130 may cover the entirety of the first surface 121 of the case 120. Further, a plane of the packaging member 140 may correspond to the shape of the second surface 122 of the case 120. For example, the packaging member 140 may have an area greater than or equal to the area of the second surface 122 of the case 120 such that the packaging member 140 can cover the entirety of the second surface 122 of the case 120.

The packaging member 140 may include a handle 142 for removal from the case 120. A user may couple the secondary battery 100 to a device via the detachment member 130 while the packaging member 140 is attached, and then the packaging member 140 can easily be removed using the handle 142 to expose the case 120. In addition, in order to make the packaging member 140 easier to remove, an adhesive layer 170 may be interposed between the packaging member 140 and the case 120. The adhesive layer 170 may be, for example, a low-adhesive adhesive layer. By using a low-adhesive adhesive, the user may remove the packaging member 140 from the case 120 without any separate tool.

A secondary battery 100 may further include a terminal portion 150 electrically connected to the electrode assembly. The terminal portion 150 may serve to electrically connect the electrode assembly to an external circuit. The terminal portion 150 may be a tab or lead respectively connected to the positive electrode and/or the negative electrode of the electrode assembly and exposed to outside of the case 120.

A secondary battery 100 may further include a protection circuit member 160 electrically connected to the terminal portion 150. For example, the protection circuit member 160 may be electrically connected to the terminal portion 150 by being in contact therewith, or by interposing a conductor between protection circuit member 160 and the terminal portion 150. The protection circuit member 160 may shut off or control the flow of current when an abnormal condition arises in the secondary battery 100. The protection circuit member 160 may include an overcharge prevention circuit, an over-discharge prevention circuit, an overcurrent prevention circuit, or a temperature sensing circuit. In some examples, the protection circuit member 160 may be a PCB that includes protection devices such as a fuse or a thermistor, as needed.

The terminal portion 150 and the protection circuit member 160 may be provided together on a side of the case 120. The side of the case 120 on which the terminal portion 150 and the protection circuit member 160 are provided may be located at a position different from either the first surface 121 to which the detachment member 130 is attached or the second surface 122 to which the packaging member 140 is attached. Specifically, the detachment member 130 or the packaging member 140 may be spaced apart from the terminal portion 150 and the protection circuit member 160.

In another example, a secondary battery 100_1 according to an embodiment of the present disclosure may include an electrode assembly (not shown) formed by stacking a first electrode, a separator, and a second electrode, with a case 120_1 accommodating the electrode assembly. A description of a configuration of the secondary battery 100_1 corresponding to the configuration of the secondary battery 100 according to the above-described embodiments will be omitted.

The secondary battery 100_1 may include a detachment member 130_1 attached to a second surface 122_2 of the case 120_1. Before attaching the detachment member 130_1, a packaging member 140_1 may be disposed on a first surface 122_1 of the case 120_1. An adhesive layer 170_1 may be interposed between the packaging member 140_1 and the case 120_1. Accordingly, before attaching the detachment member 130_1 to the second surface 122_2 of the case 120_1, the packaging member 140_1 may be removed using a handle 142_1. After that, the detachment member 130_1 may be attached to the case 120_1 using the exposed adhesive layer 170_1. Here, a first surface 121_1 of the case 120_1 opposite to the second surface 122_2 of the case 120_1 may be exposed to the outside.

According to some embodiments of the present disclosure, it is possible to provide a secondary battery configured to be easily attached to or detached from a device in the form of a pouch-type battery that is relatively light in weight and has excellent flexibility to meet demands for weight reduction.

FIG. 2 is a case and an electrode assembly accommodated in the case of a secondary battery according to an embodiment of the present disclosure.

Referring to FIG. 2, a secondary battery according to an embodiment may include an electrode assembly 210, 210_1 and a case 220 accommodating the electrode assembly 210, 210_1. The electrode assembly 210, 210_1 may include a first electrode 212, 212_1, a second electrode 214, 214_1, and a separator 216, 216_1 interposed between the first electrode 212, 212_1 and the second electrode 214, 214_1. Specifically, the electrode assembly 210, 210_1 may be formed by winding or stacking a thin plate or film-shaped first electrode 212, 212_1, separator 216, 216_1, and second electrode 214, 214_1.

The shape of the electrode assembly 210, 210_1 is not limited in the present disclosure. And the number of electrode assemblies 210, 210_1 is not limited in the present disclosure. In an embodiment, the electrode assembly 210 may be of a wound (jelly-roll) type. In another embodiment, the electrode assembly 210_1 may be of a stacked type. For instance, the electrode assembly 210_1 may be a Z-stacked electrode assembly in which the first electrode 212_1 and the second electrode 214_1 are provided to sides of a separator 216_1 folded in a Z shape. One or more electrode assemblies 210_1 may be stacked adjacent to each other along their long sides and accommodated in the case 220.

The first electrode 212, 212_1 may be either a positive electrode or a negative electrode in the electrode assembly 210, 210_1. The second electrode 214, 214_1 may be an electrode of the polarity opposite to that of the first electrode 212, 212_1. For example, if the first electrode 212, 212_1 is a positive electrode, the second electrode 214, 214_1 may be a negative electrode. Conversely, if the first electrode 212, 212_1 is a negative electrode, the second electrode 214, 214_1 may be a positive electrode.

When the first electrode 212, 212_1 is a positive electrode, the first electrode 212, 212_1 may be formed of a metal foil such as aluminum or an aluminum alloy. In another embodiment where the first electrode 212, 212_1 is a negative electrode, the first electrode 212, 212_1 may be formed of a metal foil such as copper, a copper alloy, nickel, or a nickel alloy. The same applies to the second electrode 214, 214_1.

The first electrode 212, 212_1 may be formed of a metal foil current collector made of copper, a copper alloy, nickel, or a nickel alloy, with a first electrode active material such as graphite or carbon coated on the metal foil. A first electrode tab 212a, 212a_1 may be connected to an uncoated region (a non-coated portion) on the first electrode 212, 212_1, and the first electrode tab 212a, 212a_1 may form a current flow path between the first electrode 212, 212_1 and a terminal portion 250. In some examples, the first electrode tab 212a, 212a_1 may be formed or cut to protrude from a lateral side of the first electrode 212, 212_1 during the manufacturing of the first electrode 212, 212_1, and, in other embodiments, the first electrode tab 212a, 212a_1 may protrude further outward than the separator 216, 216_1 without separate cutting.

The second electrode 214, 214_1 may be formed by coating a second electrode active material such as a transition metal oxide on a metal foil current collector made of aluminum or an aluminum alloy. A second electrode tab 214a, 214a_1 may be connected to a non-coated portion of the second electrode 214, 214_1, and the second electrode tab 214a, 214a_1 may form a current flow path between the second electrode 214, 214_1 and the terminal portion 250. In some examples, the second electrode tab 214a, 214a_1 may be preformed or cut to protrude from a lateral side, and, in other embodiments, the second electrode tab 214a, 214a_1 may protrude further outward than the separator 216, 216_1 without separate cutting.

The electrode assembly 210, 210_1 may be accommodated in the case 220 along with an electrolyte. A terminal portion 250 may be disposed in the case 220 to electrically connect outside of the case 220 with the electrode assembly 210, 210_1. The terminal portion 250 may include a first electrode terminal 252 connected to the first electrode 212, 212_1 and a second electrode terminal 254 connected to the second electrode 214, 214_1.

In FIG. 2, the first electrode terminal 252 and the second electrode terminal 254 are depicted as being positioned on the same side of the case 220, but the present disclosure is not limited to such a configuration. The first electrode terminal 252 and the second electrode terminal 254 may be partially coated with an insulator 256 to be insulated from the case 220. With the insulator 256, the electrode assembly 210, 210_1 and the case 220 remain electrically insulated from each other even though the terminal portion 250 is provided.

FIG. 3 is a cross-sectional view of a secondary battery according to an embodiment of the present disclosure coupled to a device.

Referring to FIG. 3, a secondary battery 300 according to an embodiment of the present disclosure may include a case 320 accommodating an electrode assembly, a detachment member 330 attached to a surface of the case 320, and a packaging member 340.

The detachment member 330 may include at least one detachment portion that engages a fitting portion 392 of a device 390. Specifically, the detachment portion may include a sidewall 334 formed along at least a portion of the perimeter of the detachment member 330. The sidewall 334 may include two sidewalls facing each other. At least one of these sidewalls may include a hook 336 that is detachable from the fitting portion 392 of the device 390. Here, “device” may be a general term referring to any electronic device capable of being driven by the secondary battery 300. As some examples, the device 390 may be a mobile phone, an automobile, a clock, or various types of electronic devices.

The fitting portion 392 of the device 390 is configured to fix the detachment member 330 of the secondary battery 300, and the fitting portion 392 may correspond in shape to the detachment member 330. In an embodiment, the fitting portion 392 of the device 390 includes a groove and a protrusion corresponding to the shape of the hook 336 included in the detachment member 330. The detachment member 330 may include a groove 338 that is detachable from the fitting portion 392. Specifically, the detachment member 330 may include a fitting groove 338 corresponding to a protrusion in the fitting portion 392, thereby enabling the detachment member 330 to fit to the fitting portion.

The shape of the detachment member 330 of the present disclosure and the shape of the fitting portion 392 of the device 390 are not limited to the shapes mentioned above and depicted in the figures. Other shapes commonly used in the art to mechanically couple two different rigid bodies may be used.

Descriptions of other features of the battery shown in FIG. 3 are the same as those described above with reference to FIGS. 1 and 2.

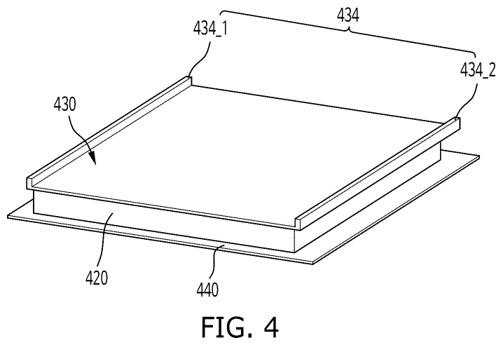

FIG. 4 illustrates an outline of a secondary battery according to an embodiment of the present disclosure.

Referring to FIG. 4, a secondary battery may include a case 420 accommodating an electrode assembly, a detachment member 430 attached to one surface of the case 420. A packaging member 440 is attached to another surface of the case 420.

In an embodiment, the detachment member 430 may include a sidewall 434 formed along at least a portion of the perimeter of the detachment member 430. The sidewall 434 may include a first sidewall 434_1 and a second sidewall 434_2 that face each other. Specifically, the first sidewall 434_1 and the second sidewall 434_2 may be formed along the perimeter of the surface of the detachment member 430 (i.e., the detachment surface in FIG. 1) that is not attached to the case 420.

In an embodiment, at least one of the first sidewall 434_1 or the second sidewall 434_2 may include a hook or a groove that is engageable with and detachable from a fitting portion of a device. For example, the first sidewall 434_1 may include a hook that is engageable with and detachable from a fitting portion in the form of a concave shape in the device, and the second sidewall 434_2 may include a groove that is engageable with and detachable from a fitting portion in the form of a concave shape in the device. In another embodiment, the second side-wall 434_2 may include a hook that is engaged with and detachable from a fitting portion in the form of a concave shape in the device, and the first sidewall 434_1 may include a groove that is engaged with and detachable from a fitting portion in the form of a concave shape in the device. In an embodiment, the first sidewall 434_1 and the second sidewall 434_2 may include hooks that are engageable to and are detachable from a fitting portion formed in a concave shape in the device. In yet another embodiment, the first sidewall 434_1 and the second sidewall 434_2 may include grooves that are engageable to and are detachable from a fitting portion formed in a concave shape in the device.

Descriptions of other features in FIG. 4 are the same as those described above with reference to FIGS. 1 to 3.

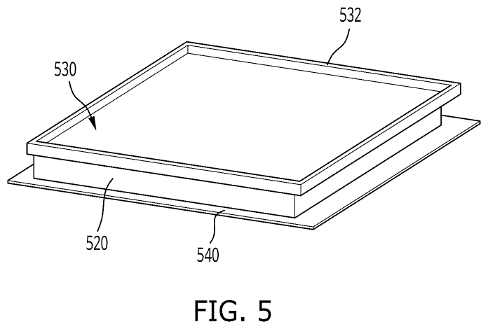

FIG. 5 illustrates an outline of a secondary battery according to an embodiment of the present disclosure.

Referring to FIG. 5, a secondary battery according may include a case 520 accommodating an electrode assembly, a detachment member 530 attached to surface of the case 520 and a packaging member 540 attached to another surface of the case 520.

In an embodiment, the detachment member 530 may include a detachment portion 532 formed along the perimeter of the detachment member 530. The detachment portion 532 may include a sidewall extending along the perimeter of the surface of the detachment member 530 (the detachment surface in FIG. 1) that is not attached to the case 520. The sidewall may include a hook or a groove that is engageable/detachable from a fitting portion of a device.

Descriptions of other features in FIG. 5 are the same as those described above with reference to FIGS. 1 to 4.

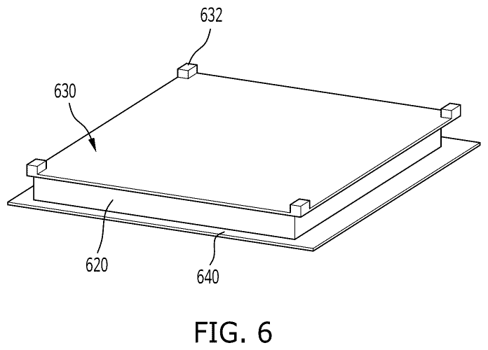

FIG. 6 illustrates an outline of a secondary battery according to an embodiment of the present disclosure.

Referring to FIG. 6, a secondary battery may include a case 620 accommodating an electrode assembly, a detachment member 630 attached to a surface of the case 620 and a packaging member 640 attached to another surface of the case 620.

The detachment member 630 may include at least one detachment portion 632 formed along at least a portion of the perimeter of the detachment member 630. The detachment portion 632 may include one or more protrusions extending from one or more corners around the perimeter of the surface of the detachment member 630 (the detachment surface in FIG. 1) that is not attached to the case 620. The protrusion(s) may include a hook or a groove that is engageable/detachable from a fitting portion of a device.

Descriptions of other features in FIG. 5 are the same as those described above with reference to FIGS. 1 to 4.

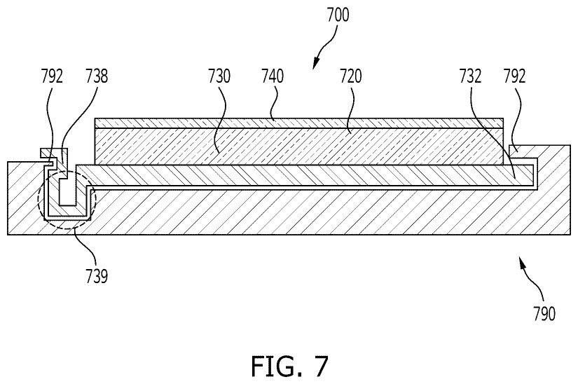

FIG. 7 is a cross-sectional view of a secondary battery according to an embodiment of the present disclosure coupled to a device.

Referring to FIG. 7, a secondary battery 700 may include a case 720 accommodating an electrode assembly, a detachment member 730 attached to a surface of the case 720, and a packaging member 740. The detachment member 730 may include at least one detachment portion 732 that engages a fitting portion 792 of a device 790. Specifically, the detachment portion 732 extends from at least a portion of the perimeter of the detachment member 730 to correspond to the fitting portion 792 of the device 790.

The detachment member 730 may include an elastic part 739. As shown in FIG. 7, the elastic part 739 may be a portion of the detachment member 730 that is formed by folding an elastic material multiple times to form a particular shape. In an example, the elastic part 739 may be formed in a U-shape, and the elastic part 739 may maintain the U-shape even if a certain amount of deformation force is applied to one end of the elastic part 739.

The elastic part 739 may face the detachment portion 732, and a groove 738 may be included at one end of the elastic part 739 to correspond to a protruding fitting portion 792 of the de-vice 790. Thus, when the detachment portion 732 of the detachment member 730 is fitted into a groove of the fitting portion 792, and when the groove 738 of the elastic part 739 is fitted onto a protrusion of the other fitting portion 792, then the secondary battery 700 is firmly supported by the device 790 to form an integrated structure. The user may subsequently separate the secondary battery 700 from the device 790 by selectively using deformation of the elastic part 739.

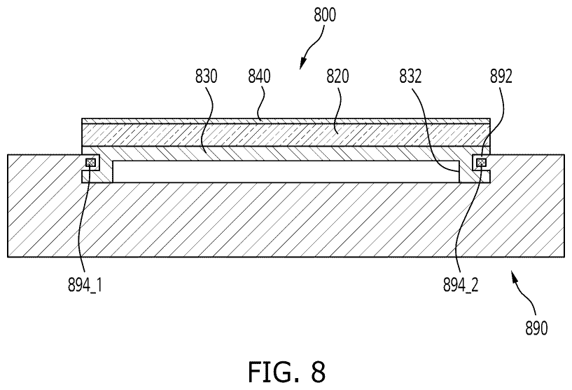

FIG. 8 is a cross-sectional view of a secondary battery according to an embodiment of the present disclosure coupled to a device.

Referring to FIG. 8, a secondary battery 800 may include a case 820 accommodating an electrode assembly, a detachment member 830 attached to a surface of the case 820, and a packaging member 840 attached to another surface of the case 820.

In an embodiment, the detachment member 830 may include at least one detachment portion 832 that engages a fitting portion 892 of a device 890. Specifically, the detachment portion 832 extend from at least a portion of the perimeter of the detachment member 830 so as to correspond to the fitting portion 892 of the device 890.

In an embodiment, the fitting portion 892 may be magnetic. And in another embodiment, the attachment member 830 may also be magnetic. Specifically, a magnetic body may be located in or around the fitting portion 892 and/or in or around the attachment member 830. The magnetic bodies of the fitting portion 892 and the attachment member 830 may attract each other, making it easier for the detachment part 832 of the attachment member 830 and the fitting portion 892 to be fitted together. Furthermore, once the fitting portion 892 and the attachment member 830 are brought together, they may be strongly joined such that the secondary battery 700 is integrated as a unit with the device 790.

The fitting portion 892 may include a first magnet 894_1 and a second magnet 894_2, and the first magnet 894_1 and the second magnet 894_2 may configured such that different poles are adjacent to each other. For example, the first magnet 894_1 may be oriented with its N-pole to the S-pole of the second magnet 894_2. In this case, if a detachment portion 832 having an S-pole is disposed at the fitting portion 892 that includes the first magnet 894_1, and a detachment portion 832 having an N-pole is disposed at the fitting portion 892 that includes the second magnet 894_2, they may be strongly coupled together. Conversely, if a detachment portion 832 having an N-pole is disposed at the fitting portion 892 that includes the first magnet 894_1, and a detachment portion 832 having an S-pole is disposed at the fitting portion 892 that includes the second magnet 894_2, the detachment portion 832 and the fitting portion 892 may not be coupled to each other, thereby guiding the user in the assembly of the structure.

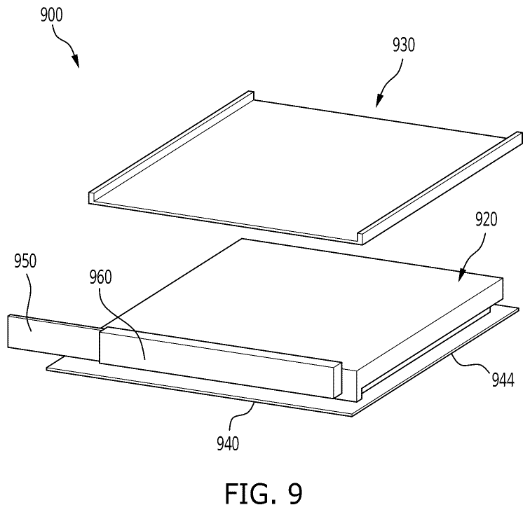

FIG. 9 illustrates an outline of a secondary battery according to an embodiment of the present disclosure.

Referring to FIG. 9, a secondary battery 900 may include a case 920 accommodating an electrode assembly, a detachment member 930 attached to a surface of the case 920, a packaging member 940 attached to another surface of the case 920, a terminal portion 950 electrically connected to the electrode assembly, and a protection circuit member 960 electrically connected to the terminal portion 950.

The packaging member 940 may include an extension part 944 that wraps around the case 920. Specifically, as described above with reference to FIG. 1, a plane of the packaging member 940 may correspond to the shape of the second surface of the case 920. In an example, the packaging member 940 may have an area greater than or equal to the area of the second surface of the case 920, and the packaging member 940 may cover portions other than the second surface of the case 920 as well.

In some embodiments, the packaging member 940 may include a flame-retardant material. Specifically, the packaging member 940 may include a flame-retardant paper, flame-retardant Styrofoam, ABS (acrylonitrile butadiene styrene), PVC (polyvinyl chloride), or another flame-retardant plastic, a flame-retardant fiber containing aramid, a ceramic-coated paper including silica or alumina, or a combination thereof. But the material of the packaging member 940 is not limited to these examples, and may be any flame-retardant material used in the art.

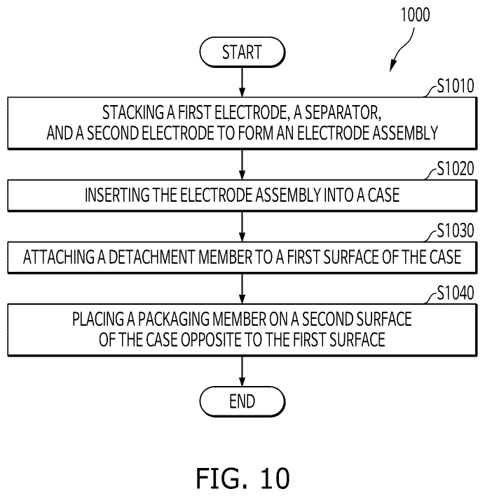

FIG. 10 is a flowchart of a method of manufacturing a secondary battery according to the present disclosure.

A method 1000 of manufacturing a secondary battery according to an embodiment of the present disclosure may begin by stacking a first electrode, a separator, and a second electrode to form an electrode assembly (S1010). Then, the electrode assembly may be inserted into a case (S1020).

Next, a detachment member may be attached to a first surface of the case (S1030). Here, a plane of the detachment member may correspond to the shape of the first surface of the case.

In an embodiment, the detachment member may include at least one detachment portion that is engageable to and detachable from a fitting portion of a device. Specifically, the detachment member may include a joining surface in contact with the first surface and a detachment surface opposite to the joining surface, the detachment portion may include a sidewall formed on the detachment surface along at least a portion of the perimeter of the detachment member, and the sidewall may protrude from the detachment surface.

In an embodiment, the sidewall may include a first sidewall and a second sidewall that face each other, and at least one of the first sidewall or the second sidewall may include a hook that is engageable to and detachable from the fitting portion. Further, the detachment portion may include a groove that is engageable to and detachable from the fitting portion. In another embodiment, the detachment member may include an elastic part.

In another embodiment, the fitting portion or the detachment member may be magnetic. Specifically, a magnetic body may be located in or around the fitting portion or the detachment member. The fitting portion may include a first magnet and a second magnet, and the first magnet and the second magnet may be oriented such that different poles are adjacent to each other.

Subsequently, a packaging member may be placed on a second surface of the case opposite to the first surface (S1040). The packaging member may include a handle for removal from the case. In addition, a plane of the packaging member may correspond to the shape of the second surface of the case. The packaging member may include a flame-retardant material.

Placing the packaging member on the second surface of the case (S1040) may include interposing an adhesive layer between the packaging member and the case.

A method 1000 of manufacturing a secondary battery according to an embodiment of the present disclosure may further include forming a terminal portion electrically connected to the electrode assembly and a protection circuit member electrically connected to the terminal portion.

Although the present disclosure has been described above with respect to embodiments thereof, the present disclosure is not limited thereto. Various modifications and variations can be made thereto by those skilled in the art within the spirit of the present disclosure.

### DESCRIPTION OF SOME REFERENCE SYMBOLS

100: secondary battery
120: case
121: first surface
122: second surface
130: detachment member
132: detachment portion
134: detachment surface
136: joining surface
140: packaging member
142: handle
150: terminal portion
160: protection circuit member
170: adhesive layer

What is claimed is:

1. A secondary battery comprising:
a case;
an electrode assembly accommodated in the case, the electrode assembly including a first electrode, a separator, and a second electrode;
a detachment member attached to a first surface of the case; and
a packaging member disposed on a second surface of the case that is opposite to the first surface,
wherein the detachment member comprises at least one detachment portion that is configured to be engageable to a fitting portion of a device.

2. The secondary battery according to claim 1, wherein the detachment member includes a joining surface in contact with the first surface of the case and a detachment surface opposite to the joining surface, and the detachment portion includes a sidewall on the detachment surface along at least a portion of a perimeter of the detachment member, the sidewall protruding from the detachment surface.

3. The secondary battery according to claim 2, wherein the sidewall includes a first sidewall and a second sidewall that face each other, and at least one of the first sidewall or the second sidewall comprises a hook that is configured to be engageable to and detachable from the fitting portion.

4. The secondary battery according to claim 1, wherein the detachment portion comprises a groove that is configured to be engageable to and detachable from the fitting portion.

5. The secondary battery according to claim 1, wherein the detachment member comprises an elastic part.

6. The secondary battery according to claim 1, wherein the detachment member is magnetic.

7. The secondary battery according to claim 6, wherein a magnetic is located in or around the detachment member.

8. The secondary battery according to claim 6, wherein the magnet is configured such that a pole of the magnet is positionable to an opposite pole of a magnet of the fitting portion.

9. The secondary battery according to claim 1, wherein the packaging member includes a handle for facilitating removal of the packaging member from the case.

10. The secondary battery according to claim 1, wherein an adhesive layer is interposed between the packaging member and the case.

11. The secondary battery according to claim 1, wherein a plane of the packaging member corresponds to a shape of the second surface of the case.

12. The secondary battery according to claim 1, wherein the packaging member comprises a flame-retardant material.

13. The secondary battery according to claim 1, wherein a plane of the detachment member corresponds to a shape of the first surface of the case.

14. The secondary battery according to claim 1, further comprising a terminal portion electrically connected to the electrode assembly, and a protection circuit member electrically connected to the terminal portion.

15. A method of manufacturing a secondary battery comprising:
stacking a first electrode, a separator, and a second electrode to form an electrode assembly;
inserting the electrode assembly into a case;
attaching a detachment member to a first surface of the case; and
placing a packaging member on a second surface of the case that is opposite to the first surface,
wherein the detachment member includes at least one detachment portion that is engageable to and detachable from a fitting portion of a device.

16. The method of manufacturing a secondary battery according to claim 15, wherein placing the packaging member on the second surface of the case comprises interposing an adhesive layer between the packaging member and the case.

17. The method of manufacturing a secondary battery according to claim 15, further comprising forming a terminal portion electrically connected to the electrode assembly and a protection circuit member electrically connected to the terminal portion.

18. The method of manufacturing a secondary battery according to claim 15, wherein the detachment member includes a joining surface in contact with the first surface of the case and a detachment surface opposite to the joining surface, and the detachment portion includes a sidewall on the detachment surface along at least a portion of a perimeter of the detachment member, with the sidewall protruding from the detachment surface.

19. The method of manufacturing a secondary battery according to claim 18, wherein the sidewall comprises a first sidewall and a second sidewall that face each other, and at least one of the first sidewall or the second sidewall comprises a hook that is engageable to and detachable from the fitting portion.

20. The method of manufacturing a secondary battery according to claim 15, wherein the detachment portion comprises a groove that is engageable to and detachable from the fitting portion.
